(19) United States
(12) Patent Application Publication
(10) Pub. No.: US 2021/0362552 A1
(43) Pub. Date: Nov. 25, 2021

(54) POLYMER PRODUCT, PREFERABLY VEHICLE TIRE

(71) Applicant: Continental Reifen Deutschland GmbH, Hannover (DE)

(72) Inventor: Markus Metz, Neustadt/OT Bordenau (DE)

(73) Assignee: Continental Reifen Deutschland GmbH, Hannover (DE)

(21) Appl. No.: 16/978,811

(22) PCT Filed: Oct. 1, 2019
(86) PCT No.: PCT/EP2019/050483

§ 371 Date: Sep. 8, 2020

(30) Foreign Application Priority Data
Mar. 9, 2018 (DE) 10 2018 203 572.5

(51) Int. Cl. B60C 13/00

(52) U.S. Cl. CPC B60C 13/001

(57) ABSTRACT

The invention relates to a polymer product, preferably a vehicle tire (1) with sidewalls (2), comprising a photorealistic representation (3) on the outer surface of the polymer product (2), wherein the photorealistic representation consists of the combination of a structure with a relief (5) of the representation, wherein the structure has elevations (7) and depressions (6) and wherein the relief (5) is a depth chart of the representation that is preferably produced on the basis of grayscale values of a photo and has up to 256 gradations of depth in such a way that the relief (5) fills the depressions (6) of the structure to different heights according to the grayscale value.

For generation of a photorealistic representation (3), the structure is an undirected texture (4) composed of elevations (7) and depressions (6).

The invention relates to a polymer product, preferably a vehicle tire with sidewalls, comprising a photorealistic representation on the outer surface of the polymer product, wherein the photorealistic representation consists of the combination of a structure with a relief of the representation, wherein the structure has elevations and depressions and wherein the relief is a depth chart of the representation that is preferably produced on the basis of grayscale values of a photo and has up to 256 gradations of depth in such a way that the relief fills the depressions of the structure to different heights according to the grayscale value.

Polymer products are, for example, automobile interior parts such as door and side trim, such as console trim, and vehicle tires. Automobile interior parts comprise plastics such as PVC, PU, TPO.

The term “representation” here includes images, company names, company logos, color markings, information data, identification codes, etc.

Representations on polymer products, especially on interior parts and tire sidewalls, should have a high quality of manufacture, create an impression of high quality, and visually identify the polymer product with respect to other polymer products. In relation to the vehicle tire, this is achieved, for example, by the applying of (colored) films to the tire sidewall. The films are typically also called “vulcanettes”. However, the applying of these films is inconvenient and costly.

It would therefore be useful to be able to apply the representations inexpensively and without separate operating steps on/in the polymer product.

A solution for this purpose is disclosed by the applicant's EP 280 95 28 B1, which forms the closest prior art. The structure here is a directed, regular, symmetrical, three-dimensional structure, for example a hatched pattern. The representation is “shaped” into the outer surface of the polymer product by an appropriately configured mold surface. No separate film, no separate polymer material and no further downstream operating step is needed to obtain the photorealistic representation in the quality of a monochrome photo.

It has been found, however, that the photorealistic representation of the closest prior art is direction-dependent, meaning that the perception of the representation is different according to the viewing direction and incidence of light on this representation.

With respect to the closest prior art, it is an object of the invention to provide an inexpensive polymer product which has on its outer surface a representation which gives the polymer product an appearance of high quality and a high quality of manufacture, but which looks almost the same from different viewing directions.

The object is achieved in that the structure is an undirected, irregular, asymmetric, three-dimensional texture composed of elevations and depressions.

The invention provides a polymer product having a photorealistic representation on its outer surface. The photorealistic representation corresponds to the quality of a black-and-white photo. This gives the polymer product an appearance of high quality and high manufacturing quality in an inexpensive manner.

The representation is “shaped” into the outer surface of the polymer product by an appropriately configured mold surface. No separate film, no separate polymer material and no further operating step is needed.

It has been found that the combination of an undirected texture with a relief of the representation to be imaged leads to a photorealistic representation that corresponds to that of a black-and-white photo and is surprisingly perceived as being about the same from any viewing angle. The image looks bionic and natural. The undirected texture means that the photorealistic representation perceived is about the same from any viewing angle. The relief can be described as a depth chart of the representation which is produced, for example, on the basis of gray values (black to white) of a photo and has up to 256 gradations of depth. The relief fills the recesses of the texture to different levels according to the gray value. The greater the degree to which the recess is filled, the lighter the appearance at this point. If the recess is unfilled, it looks black. If the recess is (roughly) completely filled, it looks virtually white. By virtue of a gradation of, for example, 256 filling levels of the recesses, a very detailed, photorealistic representation is obtained, corresponding to that of a black-and-white photo. The relief-like quality of a three-dimensional representation is distinctly surpassed by the combination of representation with texture.

The representation can project beyond the surface of the polymer product. The representation may, for example, also be integrated into the surface of the polymer product in such a way that the surface of the polymer product is flush with the surface of the texture and does not protrude from the surface of the polymer product. The representation may, however, likewise have been introduced in a recessed manner.

It is appropriate for the maximum height of the relief to correspond to 0.8 to 1.0, preferably 0.85 to 0.95, times the height of the texture.

It is appropriate for the height of the texture to be within a range from 100 μm to 1000 μm, preferably within a range from 100 μm to 500 μm, more preferably within a range from 200 μm to 300 μm, wherein the height is judged from the texture base up to the outer surface of the texture on a straight line perpendicular to the texture base.

It is appropriate for the heights of the texture elements of the textured to vary from one another by not more than 20%, proceeding from the lowest and highest texture elements.

It is appropriate for the texture base to be in a theoretical plane at a single height level.

The polymer product is preferably an interior part of a motor vehicle or a vehicle tire having the representation on at least one sidewall.

Further features, advantages and details of the invention will be discussed in detail with reference to the drawings, which illustrate schematic working examples. The drawings show:

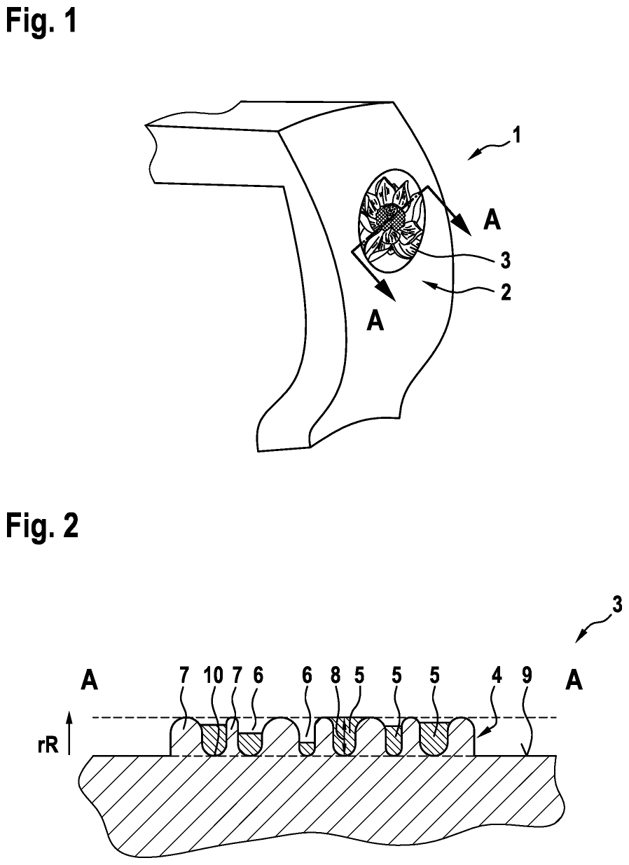

FIG. 1 a cutaway view of a vehicle tire with a photorealistic representation on the sidewall;

FIG. 2 a radial section along A-A through the photorealistic representation of the vehicle tire of FIG. 1.

FIG. 1 shows a cutaway view of a vehicle tire 1 with a sidewall 2, wherein the sidewall 2 has a photorealistic representation 3.

The radial section of FIG. 2 along the section line A-A through the photorealistic representation 3 of the vehicle tire 1 of FIG. 1 shows the principle by which the photorealistic representation 3 corresponding to that of a black-and-white photo is obtained by a texture 4 in combination with or superposed with a relief 5 of the representation. The texture 4 and the relief 5 are in an elevated arrangement relative to the surface of the sidewall 9. The texture 4 has elevations 7 as texture elements and depressions 8, and is undirected, irregular, asymmetric and three-dimensional. The relief 5 fills the depressions 6 of the texture 4 to different levels. The fill level determines the grayscale value obtained. Complete filling results in a virtually white hue. If the depression 6 is unfilled, this results in a black hue. The texture base is in a theoretical plane (lower dotted line) at one height level. The elevations 7 of the texture 4 are column-like texture elements with a hemisphere-like outer surface. The outer surface of the elevations lies in a second theoretical plane (upper dotted line). The longitudinal axis of the column-like texture elements is aligned in radial direction (rR). The height 8 of the texture lies within a range from 200 μm to 300 μm, where the height 8 is judged from the texture base 10 up to the outer surface of the texture using a straight line perpendicular to the texture base 10.

### LIST OF REFERENCE NUMERALS

### (Part of the Description)

1 Vehicle tire
2 Sidewall
3 Photorealistic representation
4 Texture
5 Relief of the representation/fill
6 Depression
7 Elevation/texture element
8 Height of the texture
9 Surface of the sidewall
10 Texture base
rR Radial direction

1.-7. (canceled)

8. A polymer product comprising a photorealistic representation on an outer surface of the polymer product, wherein the photorealistic representation consists of the combination of a structure with a relief of the representation, wherein the structure has elevations and depressions, and wherein the relief is a depth chart of the photorealistic representation that is produced on the basis of grayscale values of a photo and has up to 256 gradations of depth in such a way that the relief fills the depressions of the structure to different heights according to the grayscale value;
wherein the structure is an undirected texture composed of the elevations and the depressions; and,
wherein the polymer product may be incorporated into a vehicle tire with sidewalls.

9. The polymer product as claimed in claim 8, wherein a maximum height of the relief corresponds to 0.8 to 1.0 times of a height of the texture.

10. The polymer product as claimed in claim 8, wherein a height of the texture is within a range from 100 μm to 1000 μm, and wherein the height is judged from a base of the texture base and up to an outer surface of the texture on a straight line perpendicular to the base of the texture.

11. The polymer product as claimed in claim 8, wherein a height of texture elements of the texture varies by not more than 20%, proceeding from lowest of the texture elements and highest of the texture elements.

12. The polymer product as claimed in claim 8, wherein a base of the texture base is in a theoretical plane at a single height level.

13. The polymer product as claimed in claim 8, wherein the texture is composed of an irregular arrangement, either of soft organic texture elements comprising hemispheres or amorphous elements, or of hard angular texture elements comprising polygons, and wherein the texture contains solely similar texture elements.

14. The polymer product as claimed in claim 8, wherein the polymer product is an interior part of a motor vehicle.

15. The polymer product as claimed in claim 8, wherein the polymer product is a motor vehicle tire which has the representation on at least one sidewall of the motor vehicle tire.
